(19) United States
(12) Patent Application Publication
(10) Pub. No.: US 2026/0349369 A1
(43) Pub. Date: Nov. 5, 2026

(54) DEVELOPER SET AND IMAGE FORMING APPARATUS

(71) Applicant: KYOCERA Document Solutions Inc., Osaka (JP)

(72) Inventors: Ayano IKEMURA, Osaka (JP); Takamichi MORI, Osaka (JP); Tamotsu SHIMIZU, Osaka (JP)

(73) Assignee: KYOCERA Document Solutions Inc., Osaka (JP)

(21) Appl. No.: 19/649,865

(22) Filed: Apr. 16, 2026

(30) Foreign Application Priority Data
Apr. 25, 2025 (JP) 2025-073482

(51) Int. Cl. G03G 15/08; G03G 9/087; G03G 9/107; G03G 9/113

(52) U.S. Cl. CPC G03G 15/0865; G03G 9/08755; G03G 9/108; G03G 9/1134; G03G 9/1136

(57) ABSTRACT

A first developer includes a first toner and a first carrier, and a second developer includes a second toner and a second carrier. When a shear friction coefficient of the first carrier is A, a shear friction coefficient of the second carrier is B, a shear friction coefficient of the first developer when a surface coverage of the first toner particles with respect to one first carrier particle is 34% is C, and a shear friction coefficient of the second developer when a surface coverage of the second toner particles with respect to one second carrier particle is 34% is D, then A>C and B<D are satisfied, and 0≤|C−D|≤0.016 is satisfied.

### INCORPORATION BY REFERENCE

This application is based upon and claims the benefit of priority from the corresponding Japanese Patent Application No. 2025-073482 filed Apr. 25, 2025, the entire contents of which are hereby incorporated by reference.

### BACKGROUND

The present disclosure relates to a developer set and an image forming apparatus.

An initial developer is stored in advance in a developing device. Along with a decrease in the initial developer (toner) due to execution of printing, a replenishment developer is replenished to the developing device. In other words, a developer set including the initial developer and the replenishment developer is used for printing.

### SUMMARY

A developer set according to a first aspect of the present disclosure is used for development of an electrostatic latent image by a developing device. The developer set includes a first developer and a second developer. The first developer is stored in the developing device from start of use of the developing device. The second developer is replenished to the developing device after start of use of the developing device. The first developer includes a first toner containing first toner particles and a first carrier containing first carrier particles. The second developer includes a second toner containing second toner particles and a second carrier containing second carrier particles. When a shear friction coefficient of the first carrier is A, a shear friction coefficient of the second carrier is B, a shear friction coefficient of the first developer when a surface coverage of the first toner particles with respect to one first carrier particle is 34% is C, and a shear friction coefficient of the second developer when a surface coverage of the second toner particles with respect to one second carrier particle is 34% is D, then A>C and B<D are satisfied, and 0≤|C−D|≤0.016 is satisfied.

An image forming apparatus according to a second aspect of the present disclosure includes a developing device, a transfer unit, and a replenishment unit. The developing device develops an electrostatic latent image using the developer set. The transfer unit transfers the image developed by the developing device onto a sheet. The developing device stores the first developer from start of use of the developing device. The replenishment unit replenishes the second developer to the developing device after start of use of the developing device.

### BRIEF DESCRIPTION OF THE DRAWINGS

FIG. 1 is a schematic diagram of an image forming apparatus according to an embodiment.

FIG. 2 is a schematic diagram of a developing device and its vicinity (including a replenishment unit) according to the embodiment.

FIG. 3 is a schematic diagram of a developer set according to the embodiment.

FIG. 4 is a schematic diagram illustrating a state in a case where a toner surface coverage of the developer illustrated in FIG. 3 is less than 20%.

FIG. 5 is a schematic diagram illustrating a state in a case where the toner surface coverage of the developer illustrated in FIG. 3 is 20% to 45%.

FIG. 6 is a schematic diagram illustrating a state in a case where the toner surface coverage of the developer illustrated in FIG. 3 is more than 45%.

FIG. 7 is a graph illustrating a relationship between a shear friction coefficient of the developer set and the toner surface coverage according to the embodiment.

FIG. 8 is a schematic diagram for explaining a measurement method of a carrier resistance of the developer set according to the embodiment.

### DETAILED DESCRIPTION

### <1. Image Forming Apparatus>

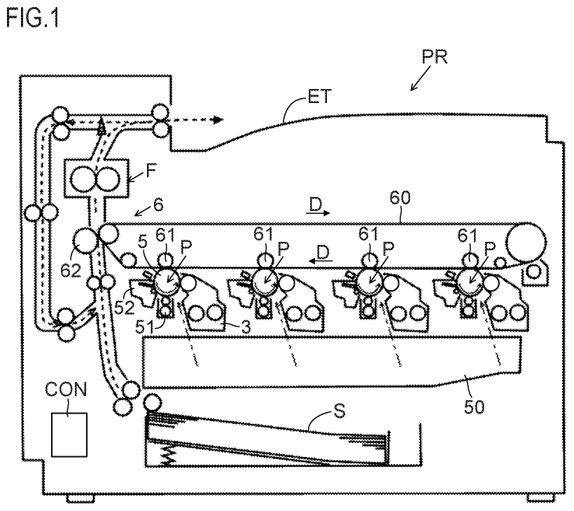

Hereinafter, with reference to FIG. 1, an image forming apparatus PR of this embodiment is described. The image forming apparatus PR is a printer.

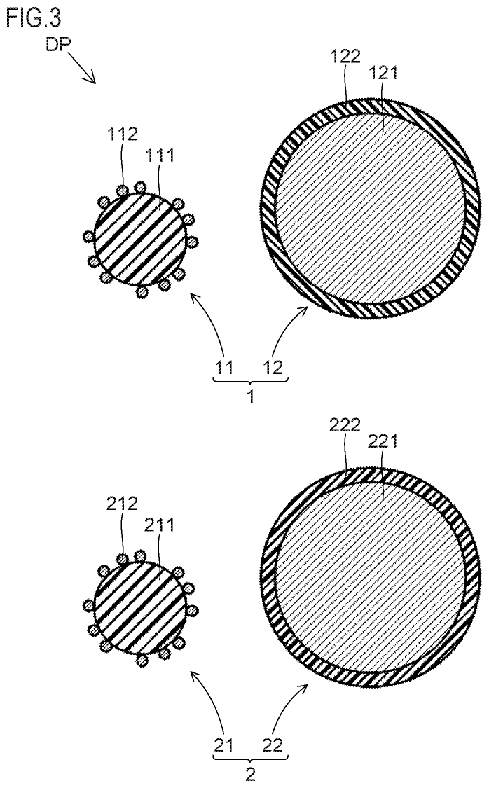

The image forming apparatus PR uses a developer set DP (see FIG. 3) so as to perform electrophotographic printing on a sheet S as a recording medium. As described later in detail, the developer set DP is a set of a first developer 1 and a second developer 2.

The image forming apparatus PR has a conveying path. In FIG. 1, the conveying path is shown by a broken line arrow. The image forming apparatus PR supplies the sheet S stored in a cassette to the conveying path, and conveys the sheet S along the conveying path. In this way, the sheet S passes through a transfer position and a fixing position in this order, and then it is discharged onto a discharge tray ET. At the transfer position, a transferring process is performed on the sheet S. At the fixing position, a fixing process is performed on the sheet S.

The image forming apparatus PR includes four image forming units P corresponding to four colors, i.e., cyan, magenta, yellow, and black colors. Each of the image forming units P forms an image using toner of the corresponding color. Hereinafter, one of the image forming units P is noted and a structure thereof is described. The image forming units P have the same basic structure. Therefore, descriptions of structures of other image forming units P are omitted by citing the following description.

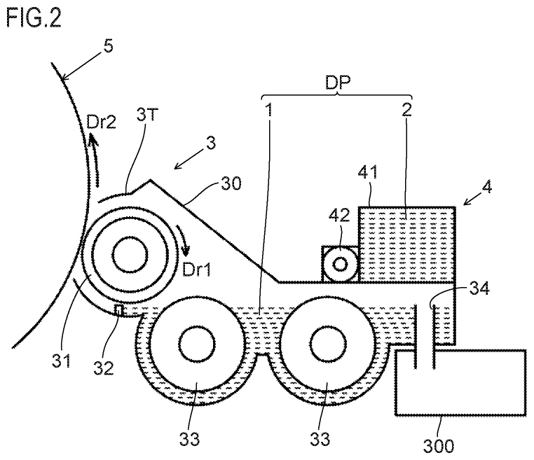

The image forming unit P includes a developing device 3. The developing device 3 is connected to a replenishment unit 4 (see FIG. 2). In addition, the image forming unit P includes a photosensitive drum 5. The photosensitive drum 5 has its outer peripheral surface as a toner carrying surface. An electrostatic latent image is formed on the outer peripheral surface of the photosensitive drum 5, and the toner is supplied to the electrostatic latent image. The photosensitive drum 5 carries the supplied toner on the outer peripheral surface.

The image forming unit P further includes a charging device 51 and a cleaning device 52. The photosensitive drum 5 constitutes one unit together with the charging device 51 and the cleaning device 52. Note that the image forming unit P includes an exposure device 50. There is one exposure device 50, which is shared by the image forming units P.

When the image forming unit P forms an image, the photosensitive drum 5 rotates. The charging device 51 is supplied with a charging voltage from a not-shown charging voltage power supply. The charging device 51 charges the photosensitive drum 5. In this way, the outer peripheral surface of the photosensitive drum 5 is charged at a predetermined potential. The exposure device 50 exposes the outer peripheral surface of the photosensitive drum 5 so as to form an electrostatic latent image on the outer peripheral surface of the photosensitive drum 5. The developing device 3 supplies the toner to the electrostatic latent image on the outer peripheral surface of the photosensitive drum 5, so as to develop the electrostatic latent image into a toner image. The replenishment unit 4 replenishes the developer to the developing device 3. The cleaning device 52 removes residual toner on the outer peripheral surface of the photosensitive drum 5.

The image forming apparatus PR includes a transfer unit 6. The transfer unit 6 transfers the toner image on the outer peripheral surface of each photosensitive drum 5 onto the sheet S. In other words, the transfer unit 6 transfers the image developed by each developing device 3 onto the sheet S.

The transfer unit 6 includes an intermediate transfer belt 60. The intermediate transfer belt 60 is an endless belt. The intermediate transfer belt 60 contacts a drum outer peripheral surface of each photosensitive drum 5, and moves (rotates) in a direction shown by an arrow D in the contact state.

The transfer unit 6 includes primary transfer rollers 61. There are a plurality of the primary transfer rollers 61, which are allotted to cyan, magenta, yellow, and black colors, respectively. The primary transfer rollers 61 are disposed on an inner peripheral side of the intermediate transfer belt 60. Each primary transfer roller 61 is disposed to face the photosensitive drum 5 that carries a toner image of a corresponding color, via the intermediate transfer belt 60 between them.

In addition, the image forming apparatus PR includes one secondary transfer roller 62. The secondary transfer roller 62 is pressed to contact an outer peripheral surface of the intermediate transfer belt 60 at a transfer position. The secondary transfer roller 62 forms a transfer nip between itself and the intermediate transfer belt 60. In other words, the transfer nip is formed at the transfer position.

In a print job, the sheet S is conveyed to the transfer position (i.e., the transfer nip). The sheet S that is being conveyed passes through the transfer nip.

The intermediate transfer belt 60 receives primary transfer of the toner image from each photosensitive drum 5. The intermediate transfer belt 60 rotates while carrying the toner image on the outer peripheral surface. While the sheet S is passing through the transfer nip, the sheet S contacts the outer peripheral surface of the intermediate transfer belt 60. In this way, the toner image is secondarily transferred to the sheet S that is passing through the transfer nip.

The image forming apparatus PR includes a fixing unit F. The fixing unit F includes a heating roller and a pressure roller. The heating roller includes a heater inside. The pressure roller is pressed to contact the heating roller. The heating roller and the pressure roller contact each other so as to form a fixing nip at a fixing position.

In a print job, the sheet S after the transfer process passes through the fixing nip. In other words, the sheet S is sandwiched between the heating roller and the pressure roller of the fixing nip. The fixing unit F heats the sheet S that is passing through the fixing nip. At the fixing nip, the sheet S is pressed. The fixing unit F performs heating and pressing on the sheet S after the transfer process passes, so as to fix the toner image to the sheet S. After the fixing process, the sheet S is discharged onto a discharge tray ET.

### <2. Developing Device>

Hereinafter, with reference to FIG. 2, the developing device 3 of this embodiment is described. Note that FIG. 2 also illustrates the replenishment unit 4 connected to the developing device 3.

The developing device 3 uses the developer set DP so as to develop the electrostatic latent image. A developing method of the developing device 3 is a trickle development method. The developing device 3 receives replenishment of the developer from the replenishment unit 4. In other words, the image forming apparatus PR includes the replenishment units 4 in addition to the developing devices 3. The replenishment unit 4 may be one component of the developing device 3.

The developing device 3 includes a development casing 30. The developer of the developer set DP is stored inside the development casing 30. The developing device 3 uses the developer stored in the development casing 30 so as to perform development. There is a case where only the first developer 1 is stored in the development casing 30, and another case where the first developer 1 and the second developer 2 are mixed and stored in the development casing 30. The developing device 3 uses the developer stored in the development casing 30 so as to perform development. Note that, in the following description, the developer stored in the development casing 30 is referred to as developer currently in use.

The developing device 3 includes a developing roller 31. The developing roller 31 is disposed inside the development casing 30 and is supported in a rotatable manner. The outer peripheral surface of the developing roller 31 is partially exposed from inside to outside of the development casing 30. Specifically, the development casing 30 has an opening at a position facing the outer peripheral surface of the photosensitive drum 5. From this opening, the outer peripheral surface of the developing roller 31 is partially exposed to the outside. In this way, the outer peripheral surface of the developing roller 31 and the outer peripheral surface of the photosensitive drum 5 face each other.

The outer peripheral surface of the developing roller 31 carries the developer currently in use, and supplies toner in the developer currently in use to the electrostatic latent image on the outer peripheral surface of the photosensitive drum 5. In this case, the developing roller 31 and the photosensitive drum 5 rotate individually. In FIG. 2, a rotation direction of the developing roller 31 is shown by an arrow Dr1, and a rotation direction of the photosensitive drum 5 is shown by an arrow Dr2.

The developing roller 31 includes a sleeve and a magnet roller. The sleeve is supported in a rotatable manner. An outer peripheral surface of the sleeve carries the developer currently in use. The magnet roller is disposed inside the sleeve (inside the cylinder thereof). The magnet roller is supported in a manner unable to rotate. The magnet roller has a plurality of magnetic poles in the circumferential direction. The sleeve can rotate about an axis of the magnet roller.

The developing device 3 includes a regulating blade 32. The regulating blade 32 is attached to the development casing 30. The regulating blade 32 is disposed so that its distal end part is adjacent to the outer peripheral surface of the developing roller 31. A distal end part of the regulating blade 32 is disposed on an upstream side of the facing area between the developing roller 31 and the photosensitive drum 5, in the rotation direction of the developing roller 31.

The developing device 3 includes two stirring screws 33. Each of the stirring screws 33 is disposed inside the development casing 30 and is supported in a rotatable manner. Each of the stirring screws 33 has a structure in which a helical blade is disposed on the rotation shaft. Each of the stirring screws 33 rotates so as to stir and convey the developer currently in use, while the toner in the developer currently in use is charged.

During rotation of the developing roller 31, the developer currently in use (specifically, the carrier carrying the toner) is attracted to the outer peripheral surface of the developing roller 31 by a magnetic force of the magnet roller, and a magnetic brush is formed on the outer peripheral surface of the developing roller 31. When the magnetic brush passes through between the developing roller 31 and the regulating blade 32, the magnetic brush is regulated to have a constant layer thickness.

In addition, a development voltage is applied to the developing roller 31. In this way, a potential difference is generated between the developing roller 31 and the photosensitive drum 5. This potential difference allows the toner in the magnetic brush to move from the developing roller 31 to the photosensitive drum 5. In other words, the toner moves to the electrostatic latent image on the outer peripheral surface of the photosensitive drum 5 (a part whose potential is decreased by exposure). As a result, the electrostatic latent image on the outer peripheral surface of the photosensitive drum 5 is developed into the toner image.

The developing device 3 has a discharge path 34. The discharge path 34 connects the inside of the development casing 30 and a collection box 300. In this way, excess developer currently in use flows into the discharge path 34, moves along the discharge path 34, and reaches the collection box 300. In other words, the collection box 300 stores the excess developer currently in use.

The replenishment unit 4 includes a container 41 and a replenishment member 42. The container 41 stores replenishment developer. The replenishment member 42 replenishes the replenishment developer stored in the container 41 to the developing device 3. For instance, the replenishment member 42 includes a screw shaft. When the screw shaft rotates, the replenishment developer is replenished from the container 41 to the inside of the development casing 30.

Note that the image forming apparatus PR includes a controller unit CON (see FIG. 1). The developing device 3 is equipped with a T/C sensor. The T/C sensor is connected to the controller unit CON. The T/C sensor detects a mixing ratio between the toner and the carrier in the developer currently in use. On the basis of an output of the T/C sensor, the controller unit CON controls replenishment of the replenishment developer from the replenishment unit 4 to the developing device 3. In other words, the controller unit CON controls the replenishment member 42 (to rotate and stop the screw shaft).

The T/C sensor is a magnetic permeability sensor and outputs a value corresponding to a magnetic permeability of the developer currently in use. As the ratio of the carrier in the developer currently in use is higher, the magnetic permeability of the developer currently in use is higher. Utilizing this fact, the mixing ratio between the toner and the carrier in the developer currently in use is detected. Further, a toner remaining amount in the developer currently in use can be detected from the detected mixing ratio.

When starting to use the developing device 3, the development casing 30 already stores initial developer inside. The initial developer is developer stored in the development casing 30 when the image forming apparatus PR is shipped (before a user uses the image forming apparatus PR). In other words, when starting to use the developing device 3, the developer currently in use contains only the initial developer.

After starting use of the developing device 3, when the print job is performed, the developer currently in use is consumed and decreased. In other words, the initial developer is decreased inside the development casing 30. For this reason, after starting use of the developing device 3, the replenishment developer is replenished from the replenishment unit 4 to the developing device 3. The developer stored in the container 41 is the replenishment developer.

While the image forming apparatus PR continues the print job, the replenishment developer is replenished into the development casing 30 while the developer currently in use is discharged from the inside of the development casing 30. In this way, inside the development casing 30, the developer currently in use is gradually changed, i.e., the initial developer is gradually replaced by the replenishment developer. In other words, the initial developer and the replenishment developer are mixed as the developer currently in use.

### <3. Developer Set>

Hereinafter, with reference to FIG. 3, the developer set DP of this embodiment is described.

The developer set DP contains the first developer 1 and the second developer 2. The first developer 1 and the second developer 2 are stored in the developing device 3 and is used for developing the electrostatic latent image by the developing device 3.

Here, the first developer 1 is the initial developer, and is stored in the development casing 30 from start of use of the developing device 3. On the other hand, the second developer 2 is the replenishment developer, and is stored in the container 41 at start of use of the developing device 3. In other words, at start of use of the developing device 3, it is in the state illustrated in FIG. 2.

Each of the first developer 1 and the second developer 2 is a two-component developer containing the toner and the carrier. The toner and the carrier of the first developer 1 correspond to a “first toner” and a “first carrier”, respectively. In the following description, the toner and the carrier in the first developer 1 are referred to as the first toner and the first carrier. The toner and the carrier of the second developer 2 correspond to a “second toner” and a “second carrier”. In the following description, the toner and the carrier in the second developer 2 are referred to as the second toner and the second carrier, respectively.

The first toner contains first toner particles 11, and the first carrier contains first carrier particles 12. The second toner contains second toner particles 21, and the second carrier contains second carrier particles 22. The first toner is an aggregate of the first toner particles 11, and the first carrier is an aggregate of the first carrier particles 12. The second toner is an aggregate of the second toner particles 21, and the second carrier is an aggregate of the second carrier particles 22. FIG. 3 schematically illustrate the first toner particle 11, the first carrier particle 12, the second toner particle 21, and the second carrier particle 22, as each single particle.

### <3-1. First Developer>

The first toner particle 11 has a first toner mother particle 111. The first toner mother particle 111 is, for example, a non-encapsulated toner mother particle without a shell layer. The first toner mother particle 111 may be an encapsulated toner mother particle in which a toner core is coated with a shell layer.

The first toner mother particle 111 contains binder resin, for example. As the binder resin, a thermoplastic resin such as polyester resin may be used. The first toner mother particle 111 may contain a coloring agent, a charge control agent, a mold release agent, and the like.

The first toner particle 11 has first external additive particles 112. The first external additive particles 112 adhere to the surface of the first toner mother particle 111. As the first external additive particles 112, silica particles and aluminum oxide particles may be used. In addition, if necessary, resin particles, magnesium oxide particles, zinc oxide particles, and the like may be used as the first external additive particles 112.

In the first toner particle 11, the contained amount of the silica particles is preferably 0.1 pts. mass or more and 10.0 pts. mass or less, and more preferably 0.4 pts. mass or more and 3.0 pts. mass or less, with respect to 100.0 pts. mass of the first toner mother particle 111. In addition, the mean primary particle diameter of the silica particle is preferably 10 nm or more and 30 nm or less, and more preferably 15 nm or more and 25 nm or less. The silica particle may be surface treated.

The contained amount of the aluminum oxide particles in the first toner particle 11 is preferably 0.05 pts. mass or more and 3.0 pts. mass or less, and more preferably 0.3 pts. mass or more and 1.5 pts. mass or less, with respect to 100.0 pts of the first toner mother particle 111. In addition, the mean primary particle diameter of the aluminum oxide particle is preferably 200 nm or more and 600 nm or less, and more preferably 300 nm or more and 500 nm or less.

Note that the mean primary particle diameter in this specification is a mean value of equivalent circle diameters of primary particles measured using a scanning electron microscope (a Heywood diameter: a diameter of a circle having the same area as a projected area of the primary particle). The mean primary particle diameter is, for example, a mean value of equivalent circle diameters of 100 primary particles. For measuring the mean primary particle diameter, a field emission type scanning electron microscope (“JSM-7600F” manufactured by Japan Electron Optics Laboratory Co., Ltd.) can be used.

The first carrier particle 12 has a first carrier core 121. The first carrier core 121 contains magnetic material. The first carrier core 121 may contain only one type of magnetic material, or may contain two or more types of magnetic materials. As the magnetic material, it is possible to use a metal oxide such as ferrite, magnetite, or maghemite. Note that the ferrite has high flowability and chemical stability tendency. For this reason, it is preferred that the first carrier core 121 contain ferrite. As an example of the ferrite, there are Ba ferrite, Mn ferrite, Mn—Zn ferrite, Ni—Zn ferrite, Mn—Mg ferrite, Ca—Mg ferrite, Li ferrite, and Cu—Zn ferrite.

An average particle diameter of the first carrier core 121 is 20 μm or more and 60 μm or less. If the average particle diameter of the first carrier core 121 is less than 20 μm, carrier development easily occurs, in which the carrier adheres to the photosensitive drum 5. If the carrier development occurs, the carrier moves from the photosensitive drum 5 to the intermediate transfer belt 60, which causes transfer voids. Further, the carrier is sent to a cleaning member of the intermediate transfer belt 60, and hence cleaning defective can occur. On the other hand, if the average particle diameter of the first carrier core 121 is more than 60 μm, the magnetic brush on the developing roller 31 becomes coarse, and image quality is deteriorated. For this reason, it is preferred that the average particle diameter of the first carrier core 121 be 20 μm or more and 60 μm or less. A shape of the first carrier core 121 is not particularly limited, and it may be an irregular shape or a spherical shape.

In addition, a saturation magnetization of the first carrier core 121 is 65 emu/g or more and 90 emu/g or less. If the saturation magnetization of the first carrier core 121 is low, carrier development may occur so that image quality is deteriorated. On the other hand, it is difficult to produce carrier cores having a relatively high saturation magnetization. For this reason, it is preferred that the saturation magnetization of the first carrier core 121 be 65 emu/g or more and 90 emu/g or less. If the first carrier core 121 contains Mn ferrite, the saturation magnetization of the first carrier core 121 has tendency to be lower as content of Mn is higher. If the first carrier core 121 contains Mn—Mg ferrite, the saturation magnetization of the first carrier core 121 has tendency to be lower as content of Mg is higher.

Note that the saturation magnetization in this specification is a value measured using a high-sensitivity vibrating sample magnetometer (“VSM-P7” manufactured by TOEI KOGYO CO., LTD.) under condition of an external magnetic field of 3,000 (unit: Oe).

The first carrier particle 12 has a first coat layer 122. The first coat layer 122 covers the surface of the first carrier core 121. For instance, the entire surface of the first carrier core 121 is covered with the first coat layer 122.

The first coat layer 122 contains coat resin. The coat resin of the first coat layer 122 contains silicone resin as a main component. In other words, a principal component of the coat resin of the first coat layer 122 in mass base is silicone resin. For instance, the coat resin of the first coat layer 122 contains only silicone resin. The coat resin of the first coat layer 122 may further contain a resin other than silicone resin.

As a preferred example of the silicone resin, there are silicone resin having a methyl group, and epoxy modified silicone resin. An example of the silicone resin having a methyl group is a silicone resin that has a methyl group but does not have a phenyl group. Another example of the silicone resin having a methyl group is a silicone resin that has a methyl group and a phenyl group.

The first coat layer 122 contains barium titanate particles. The barium titanate particles have different characteristics depending on the production method. For instance, a barium titanate particle produced by a hydrothermal synthesis method has a small true specific gravity because it has voids inside, and also has a sharp particle size distribution. For this reason, the barium titanate particles produced by the hydrothermal synthesis method have a better dispersibility in the coat resin than barium titanate particles produced by other production method, and uniform dispersion can be achieved. Therefore, the barium titanate particles produced by the hydrothermal synthesis method can also achieve uniform charging performance of the carrier, and are suitable for use.

It is preferred that the mean primary particle diameter of the barium titanate particle be 100 nm or more and 500 nm or less. If the mean primary particle diameter of the barium titanate particle is less than 100 nm, a dielectric constant of the barium titanate particles rapidly drops, and effects due to the dielectric constant are decreased. On the other hand, if the mean primary particle diameter of the barium titanate particle is more than 500 nm, uniform dispersion becomes difficult. Therefore, the first coat layer 122 contains the barium titanate particles having a mean primary particle diameter of 102 nm.

It is preferred that a contained amount of the barium titanate particles be 5 pts. mass or more and 45 pts. mass or less with respect to 100 pts. mass of the coat resin. If the contained amount of the barium titanate particles is less than 5 pts. mass, a ferroelectric effect is decreased. On the other hand, if the contained amount of the barium titanate particles is more than 45 pts. mass, the barium titanate particles cannot be sufficiently contained in the coat resin, and the barium titanate particles will separate from the coat resin. Therefore, the first coat layer 122 contains 10 pts. mass of barium titanate particles with respect to 100 pts. mass of the coat resin.

The first coat layer 122 contains carbon black particles. Because the carbon black particles are conductive material, if the first coat layer 122 contains the carbon black particles, charges move smoothly from the first carrier particles 12 to the toner particles in the developer currently in use. As a result, the toner particles in the developer currently in use can be charged at a desired charge amount. In this way, an image having little fogging can be formed. In addition, even if the toner concentration in the developer currently in use is changed, a fluctuation of the toner charge amount can be small, and images having desired density can be stably formed.

It is preferred that the contained amount of the carbon black particles in the first coat layer 122 be 2 pts. mass or more and 6 pts. mass or less with respect to 100 pts. mass of the coat resin. It is because if the contained amount of the carbon black particles is less than 2 pts. mass, the resistance becomes high so that the charges cannot be sufficiently moved. On the other hand, if the contained amount of the carbon black particles is more than 6 pts. mass, the resistance becomes low so that a leakage will easily occur.

The first coat layer 122 contains a ferroelectric material (the barium titanate particles) and a conductive material (the carbon black particles). In this way, the following effect can be obtained.

The ferroelectric material has a high charge retaining ability, and can supply sufficient charges to the toner particles in the developer currently in use. The conductive material can move charges smoothly from the carrier particles to the toner particles in the developer currently in use. By synergy of these two effects, even if the toner concentration in the developer currently in use (corresponding to a toner surface coverage described later) is increased so that the number of toner particles to be charged is increased, it is possible to supply the charges up to a saturation charge amount level of the toner particles.

Note that, normally, charges cannot be supplied up to the saturation charge amount level of the toner particles, and hence the charge amount is decreased along with an increase in the toner concentration in the developer currently in use. However, using both the dielectric material and the conductive material, the charge supply ability is improved, and the charge amount is hardly decreased even if the toner concentration in the developer currently in use is increased. Therefore, it is preferred that the first coat layer 122 be made of the coat resin in which a ferroelectric material (the barium titanate particles) and a conductive material (the carbon black particles) are added.

### <3-2. Second Developer>

The second toner particle 21 is the same toner particle as the first toner particle 11. In other words, the second toner particle 21 has a second toner mother particle 211 and second external additive particles 212 adhered to the surface of the second toner mother particle 211. Further, the second toner mother particle 211 is the same as the first toner mother particle 111. In addition, the second external additive particle 212 is the same as the first external additive particle 112. For this reason, description of the second toner particle 21 (the second toner mother particle 211 and the second external additive particles 212) is omitted by citing the description of the first toner particle 11 (the first toner mother particle 111 and the first external additive particles 112).

The second carrier particle 22 have a second carrier core 221. The second carrier core 221 is made of the same raw material as the first carrier core 121. For this reason, description of the second carrier core 221 is omitted by citing the description of the first carrier core 121.

An average particle diameter of the second carrier core 221 is 20 μm or more and 60 μm or less. A saturation magnetization of the second carrier core 221 is 65 emu/g or more and 90 emu/g or less. The reason why the average particle diameter and the saturation magnetization of the second carrier core 221 should be in the above ranges is the same as for the first carrier core 121. In addition, a shape of the second carrier core 221 may be an irregular shape or a spherical shape, in the same manner as the first carrier core 121.

The second carrier particle 22 has a second coat layer 222. The second coat layer 222 covers the surface of the second carrier core 221. For instance, the entire surface of the second carrier core 221 is coated with the second coat layer 222.

The second coat layer 222 contains the coat resin in the same manner as the first coat layer 122. However, the coat resin of the second coat layer 222 contains at least fluorocarbon resin. For instance, the coat resin of the second coat layer 222 contains fluorocarbon resin and polyimide resin.

The second coat layer 222 contains carbon black particles. Because the second coat layer 222 contains the carbon black particles, the same effect as the first coat layer 122 can be obtained. It is preferred that the contained amount of the carbon black particles in the second coat layer 222 be 2 pts. mass or more and 6 pts. mass or less with respect to 100 pts. mass of the coat resin. The reason is the same as the first coat layer 122.

Note that, unlike the first coat layer 122, the second coat layer 222 may not necessarily contain barium titanate particles.

### <4. Shear Friction Coefficient of Developer>

Hereinafter, shear friction coefficients of the first developer 1 (the initial developer) and the second developer 2 (the replenishment developer) are described.

In the following description, if it is not necessary to distinguish between the first developer 1 and the second developer 2, these two are collectively referred to as a developer (without numeral). If it is not necessary to distinguish between the first toner particle 11 and the second toner particle 21, these two are collectively referred to as a toner particle (without numeral). If it is not necessary to distinguish between the first carrier particle 12 and the second carrier particle 22, these two are collectively referred to as a carrier particle (without numeral).

### <4-1. Definition of Shear Friction Coefficient>

The shear friction coefficient of the developer is determined on the basis of a measurement result using a powder bed shear stress measurement device (“NS-S500” manufactured by Nano Seeds Corporation). This measurement is performed in accordance with JISZ8835:2016. A powder layer of the developer is a measuring object.

The powder bed shear stress measurement device is equipped with a shear cell constituted of an upper fixed cell and a lower movable cell. The upper fixed cell has a cylindrical shape. The lower movable cell has a recess indented from the top surface downward. The upper fixed cell is disposed on the top surface of the lower movable cell. The lower movable cell can move laterally with respect to the upper fixed cell. When filling the measuring object into the shear cell, the recess space of the lower movable cell is aligned to the inner space of the cylinder as the upper fixed cell in the up and down direction. Then, the sample is filled into the inner space of the cylinder of the upper fixed cell (including the recess space of the lower movable cell). Note that the sample may be the developer including the toner and carrier, or may be only the carrier.

When measuring the shear friction coefficient of the developer (or the carrier), the sample is filled into the shear cell, and the top surface of the powder layer is flattened. After that, while moving the lower movable cell horizontally, a downward indentation load on the powder layer is changed in five steps (5N, 10N, 15N, 20N, and 25N) so as to measure a normal stress and a shear stress along time, and the five points are plotted on a graph, in which the vertical axis represents the shear stress while the horizontal axis represents the normal stress. Then, the approximate straight line of the five points is drawn on the graph, and a value of a gradient tan 0 of the straight line is determined as the shear friction coefficient of the developer (or the carrier).

Measurement conditions of the shear friction coefficient of the developer (or the carrier) are as follows.
sample amount: 15 g
sampling frequency: 10 Hz
device configuration identification symbol: BF82XB
upper fixed cell inner diameter: 30 mm
lower movable cell depth: 5 mm
shear speed: 10 μm/sec
shear band thickness: 0.2 mm
compression speed: 0.2 mm/sec

### <4-2. Adhesion of Toner Particles to Carrier Particle>

The toner particles have different behaviors depending on adhesion of the toner particle to the carrier particle. The difference affects the shear friction coefficient of the developer.

If the adhesion of the toner particle to the carrier particle is relatively weak, the toner particles can move on the carrier particles. In this case, the toner particles work as a lubricant. For this reason, as a surface coverage of the toner particles on one carrier particle (hereinafter, simply referred to as toner surface coverage) is higher, the shear friction coefficient of the developer is smaller.

If the adhesion of the toner particle to the carrier particle is strong, the toner particles are fixed on the carrier particle. In this case, the toner particles makes the carrier particle to have an irregular shape. For this reason, as the toner surface coverage is higher, the shear friction coefficient of the developer is larger.

### <4-3. Surface Coverage of Toner Particles on Carrier Particle>

As the number of the toner particles existing on the surface of the carrier particle and around the same is larger, the toner surface coverage is higher, while the number of the toner particles existing on the surface of the carrier particle and around the same is smaller, the toner surface coverage is lower. In other words, the toner surface coverage of the developer corresponds to the toner concentration of the developer. The toner surface coverage of the developer affects the shear friction coefficient of the developer.

When a volume average particle diameter of the toner particle is r, a volume average particle diameter of the carrier particle is R, and the number of the toner particles with respect to one carrier particle is n, then the toner surface coverage of the developer is calculated by the following equation.

toner surface coverage (%)=(nr²)/(4R²)×100

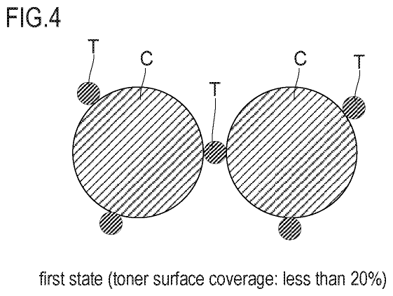

Here, a state of the developer can be classified into three, i.e., a first state, a second state, and a third state, in accordance with a difference of a toner surface coverage. The first to the third states are schematically illustrated in FIGS. 4 to 6, respectively. In FIGS. 4 to 6, the carrier particle is denoted by C. In addition, the toner particle is denoted by T. However, for convenience's sake, a part of toner particles are denoted by T. In addition, in the following description, one carrier particle and the other carrier particle, which are adjacent to each other, are noted.

The state illustrated in FIG. 4 is the first state, in which the toner surface coverage is less than 20%. In the first state, there is a region where the toner particle on the one carrier particle contacts the other carrier particle directly.

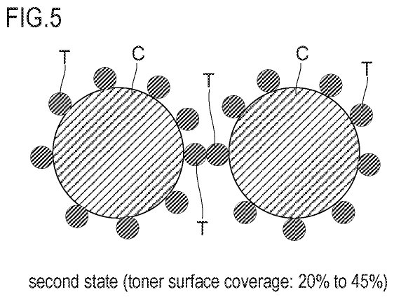

The state illustrated in FIG. 5 is the second state, in which the toner surface coverage is 20% or more and 45% or less. In the second state, there is always a region where the toner particle on the one carrier particle contacts the toner particle on the other carrier particle.

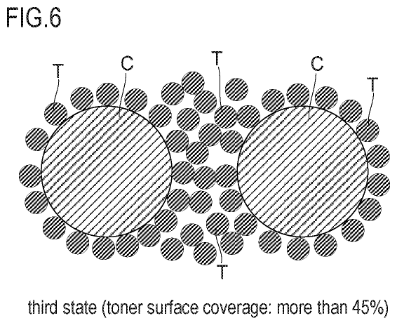

The state illustrated in FIG. 6 is the third state, in which the toner surface coverage is more than 45%. In the third state, there is the toner particle that is not held on the carrier particle but is floating.

Note that, according to the calculation, when the particles are arranged in square, the toner surface coverage is 78.5%. However, in fact, because the toner particles are charged at the same polarity, they are repelled by each other, and the toner surface coverage does not reach 78.5% but has a limitation of approximately 50%. In other words, in actual use, it becomes the second state (see FIG. 5).

### <4-4. Coat Material of Carrier Particle>

In the first developer 1 as the initial developer, a coating material of the first carrier particle 12 contains silicone resin. In the second developer 2 as the replenishment developer, the coating material of the second carrier particle 22 contains fluorocarbon resin. This difference of the coating material causes a difference between the adhesion of the first toner particle 11 to the first carrier particle 12, and the adhesion of the second toner particle 21 to the second carrier particle 22.

In the first developer 1, the adhesion of the first toner particle 11 to the first carrier particle 12 is weaker than the adhesion of the second toner particle 21 to the second carrier particle 22. Therefore, because the toner particles T work as a lubricant in the first state (see FIG. 4), in the first developer 1, the shear friction coefficient is decreased along with an increase in the toner surface coverage (the toner concentration). In the second state (FIG. 5), the number of the toner particles T working as a lubricant is increased, but the range to work as a lubricant is decreased because of the increasing number of toner particles T. In this way, in the first developer 1, although the toner surface coverage (the toner concentration) is increased, the shear friction coefficient is not changed so much.

In the second developer 2, the adhesion of the second toner particle 21 to the second carrier particle 22 is stronger than the adhesion of the first toner particle 11 to the first carrier particle 12. Therefore, in the first state (see FIG. 4), the toner particles T are fixed to the carrier particle C. In the second state (see FIG. 5), the number of the toner particles T fixed to the carrier particle C is increased, and the shear friction coefficient becomes larger than that in the first state. In this way, in the second developer 2, along with an increase in the toner surface coverage (the toner concentration), the shear friction coefficient is increased.

Note that in the third state (see FIG. 6), a sufficient number of the toner particles T adhere to the carrier particle C, and hence floating toner particles T occur. The floating toner particle T work as a lubricant. In this way, if the toner surface coverage is more than 45%, regardless of whether the coating material of the carrier particle C is silicone resin or fluorocarbon resin, the shear friction coefficient is decreased along with an increase in the toner surface coverage (the toner concentration).

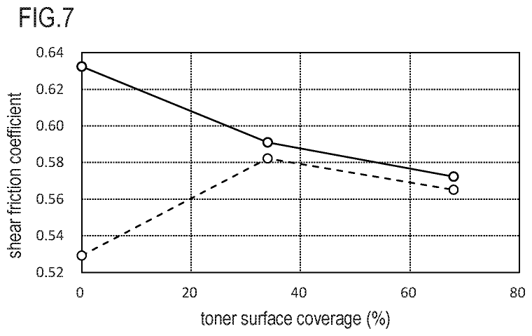

Here, a relationship between the shear friction coefficient of the developer and the toner surface coverage is illustrated in FIG. 7. In the graph illustrated in FIG. 7, the vertical axis represents the shear friction coefficient of the developer, while the horizontal axis represents the toner surface coverage of the developer.

A solid line in the graph indicates a relationship between the shear friction coefficient and the toner surface coverage of the first developer 1 (the coating material contains silicone resin). On the other hand, a broken line in the graph indicates a relationship between the shear friction coefficient and the toner surface coverage of the second developer 2 (the coating material contains fluorocarbon resin). Note that if the toner surface coverage is 0%, only the carrier exists in the developer (i.e., there is no toner around the carrier). For this reason, in the measurement of the shear friction coefficient when the toner surface coverage is 0%, only the carrier is the measuring object.

When the toner surface coverage is 0%, the shear friction coefficient of only the first carrier in the first developer 1 is 0.632. On the other hand, when the toner surface coverage is 0%, the shear friction coefficient of only the second carrier in the second developer 2 is 0.529. In other words, when the toner surface coverage is 0%, the shear friction coefficient of the first carrier is larger than the shear friction coefficient of the second carrier.

When the toner surface coverage is 34% (approximately the center of the second state), the shear friction coefficient of the first developer 1 (including the first toner and the first carrier) is 0.591. When the toner surface coverage is 34%, the shear friction coefficient of the second developer 2 (including the second toner and the second carrier) is 0.582. In addition, in the first developer 1, the shear friction coefficient is larger when the toner surface coverage is 0% than when the toner surface coverage is 34%. In the second developer 2, the shear friction coefficient is smaller when the toner surface coverage is 0% than when the toner surface coverage is 34%.

When the toner surface coverage is 68%, the shear friction coefficient of the first developer 1 (including the first toner and the first carrier) is 0.572. When the toner surface coverage is 68%, the shear friction coefficient of the second developer 2 (including the second toner and the second carrier) is 0.565. In other words, when the toner surface coverage is 68%, each shear friction coefficient of the first developer 1 and the second developer 2 is smaller than that when the toner surface coverage is 34%.

From the above facts, it can be said that the developer having the shear friction coefficient, which is smaller when the toner surface coverage is 34% than when the same is 0%, has a weak adhesion of the toner particle to the carrier particle. It can be said that the developer having the shear friction coefficient, which is larger when the toner surface coverage is 34% than when the same is 0%, has a strong adhesion of the toner particle to the carrier particle.

In other words, it can be said that the developer containing the carrier particles whose coating material contains silicone resin (i.e., the first developer 1) has a weak adhesion of the toner particle to the carrier particle. It can be said that the developer containing the carrier particles whose coating material contains fluorocarbon resin (i.e., the second developer 2) has a strong adhesion of the toner particle to the carrier particle.

Here, if the adhesion of the toner particle to the carrier particle is large, an amount of toner that moves for developing is decreased, and developing performance is lowered. On the other hand, if the adhesion of the toner particle to the carrier particle is weak, the toner particles are easily scattered in the development process. In particular, in durability (in long-term use), the state where the toner particles are easily scattered can occur. If the toner particles are largely scattered, a recording medium can be contaminated. In addition, it is difficult to clean the inside of the apparatus.

For this reason, it is preferred that the initial developer be the developer having a weak adhesion of the toner particle to the carrier particle. In addition, it is preferred that the replenishment developer be the developer having a strong the adhesion of the toner particle to the carrier particle, in consideration of use in durability.

Therefore, in this embodiment, the first developer 1 is used as the initial developer. The second developer 2 is used as the replenishment developer. In other words, the developer having a weak adhesion of the toner particle to the carrier particle is used as the initial developer. The developer having a strong the adhesion of the toner particle to the carrier particle is used as the replenishment developer.

Note that using the first developer 1 as the initial developer while using the second developer 2 as the replenishment developer means that the following inequalities (1) to (3) are all satisfied.

A>C (1)

B<D (2)

0≤|C−D|≤0.016 (3)

In the above inequalities (1) to (3), the shear friction coefficient of only the first carrier in the first developer 1 (i.e., the shear friction coefficient when the toner surface coverage is 0%) is represented by A, and the shear friction coefficient of only the second carrier in the second developer 2 (i.e., the shear friction coefficient when the toner surface coverage is 0%) is represented by B. In addition, the shear friction coefficient of the first developer 1 when the surface coverage of the first toner particles 11 with respect to one first carrier particle 12 is 34% is represented by C, and the shear friction coefficient of the second developer 2 when the surface coverage of the second toner particle 21 with respect to one second carrier particle 22 is 34% is represented by D.

The shear friction coefficient of only the first carrier in the first developer 1 is 0.632 (=A), and the shear friction coefficient of the first developer 1 when the surface coverage of the first toner particles 11 with respect to one first carrier particle 12 is 34% is 0.591 (=C). In this way, the above inequality (1) is satisfied.

The shear friction coefficient of only the second carrier of the second developer 2 is 0.529 (=B), and the shear friction coefficient of the second developer 2 when the surface coverage of the second toner particle 21 with respect to one second carrier particle 22 is 34% is 0.582 (=D). In this way, the above inequality (2) is satisfied.

The shear friction coefficient of the first developer 1 when the surface coverage of the first toner particles 11 with respect to one first carrier particle 12 is 34% is 0.591 (=C), and the shear friction coefficient of the second developer 2 when the surface coverage of the second toner particle 21 with respect to one second carrier particle 22 is 34% is 0.582 (=D). In this way, the above inequality (3) is satisfied.

In this embodiment, the first developer 1 is used as the initial developer while the second developer 2 is used as the replenishment developer 2, and hence the above inequalities (1) to (3) are satisfied. In this way, it is possible to suppress deterioration of image quality while suppressing scatter of toner from the inside to the outside of the developing device 3 for a long period.

In addition, in this embodiment, the first developer 1 and the second developer 2 have substantially the same shear friction coefficient, within a range of the toner surface coverage in real use (the toner surface coverage is approximately 34%). In this way, even if the developer currently in use in the developing device 3 is gradually changed, i.e., even if the first developer 1 is gradually replaced by the second developer 2, the flowability of the developer currently in use is stabilized. In other words, an amount of the developer remaining in the developing device 3 is stabilized.

From this fact, it can be said that it is more preferable to satisfy the following inequality (4). In other words, it can be said that it is more preferable that the first developer 1 and the second developer 2 have substantially the same shear friction coefficient when the toner surface coverage is 34%.

0≤|C−D|≤0.009 (4)

The shear friction coefficient of the first developer 1 when the surface coverage of the first toner particles 11 with respect to one first carrier particle 12 is 34% is 0.591 (=C), and the shear friction coefficient of the second developer 2 when the surface coverage of the second toner particle 21 with respect to one second carrier particle 22 is 34% is 0.582 (=D). In this way, the above inequality (4) is satisfied.

Note that if the first carrier particle 12 and the second carrier particle 22 have largely different resistances, an image density may not be secured. About this, the image density can be stabilized to some extent by adjusting a developing bias. However, an adjustable range of the developing bias has a limitation.

For this reason, it is preferred that the resistances of the first carrier particle 12 and the second carrier particle 22 are close to each other. For instance, if the resistance of the first carrier particle 12 is approximately 10¹⁰Ω, it is preferred that the resistance of the second carrier particle 22 be 109 to 10¹⁰Ω.

### <5. Confirmation Experiment>

Hereinafter, an experiment is described, which was performed for checking the above effects of this embodiment.

### <5-1. Preparation of Toner>

The toner of the developer to be used for the confirmation experiment was prepared by the following method.

### <5-1-1. Synthesis of Amorphous Polyester Resin>

A reaction container, equipped with a thermometer (thermocouple), a dewatering conduit, a nitrogen gas introduction conduit, and a stirring device (stirring blade), was set in an oil bath. Then, 1,575 g of bisphenol A propylene oxide additive (BPA-PO), 163 g of bisphenol A ethylene oxide additive (BPA-EO), 377 g of fumaric acid, and 4 g of catalyst (dibutyltin oxide) were put into the reaction container.

After creating a nitrogen atmosphere in the reaction container, the temperature inside the reaction container was raised to 220 degrees Celsius while stirring the contents. Under the conditions of the nitrogen atmosphere and the temperature of 220 degrees Celsius, polymerization reaction of the contents in the reaction container was performed for 8 hours while removing by-product water. Next, the pressure inside the reaction container is reduced, and under the conditions of the reduced pressure atmosphere (pressure: 7,999 Pa) and the temperature of 220 degrees Celsius, the polymerization reaction of the contents in the reaction container was performed for more and 1 hour. In addition, the temperature inside the reaction container was reduced to 210 degrees Celsius, and then 336 g of trimellitic anhydride was added into the reaction container. Then, under the conditions of the reduced pressure atmosphere (pressure: 7,999 Pa) and the temperature of 210 degrees Celsius, reaction of the contents in the reaction container was performed. After that, the reaction product was taken out from the reaction container and was cooled, and hence the amorphous polyester resin having the following physical properties was obtained. Note that the polyester resin obtained in this way did not clearly show its endothermic peak in the endothermic curve measured using a differential scanning calorimeter, and its clear melting point was not able to be measured, and thus it was determined to be amorphous.
softening point (Tm): 100 degrees Celsius
glass transition point (Tg): 50 degrees Celsius
mass average molecular weight (Mw): 30,000
acid value: 15 mgKOH/g
hydroxyl value: 30 mgKOH/g

### <5-1-2. Preparation of Toner Mother Particles>

Using an FM mixer (“FM-10b” manufactured by Nippon Coke & Engineering Co., Ltd.), 100 pts. mass of binder resin, 4 pts. mass of coloring agent, 1 pts. mass of charge control agent, and 5 pts. mass of mold release agent were mixed, so that the mixture was obtained. As the binder resin, the amorphous polyester resin described above was used. As the coloring agent, copper phthalocyanine blue pigment (C.I. Pigment Blue 15:3) was used. As the charge control agent, quaternary ammonium salt (“BONTRON (registered trademark) P-51” manufactured by Orient Chemical Industries Co., Ltd.) was used. As the mold release agent, carnauba wax (“Special Carnauba Wax 1st” manufactured by S. KATO & CO.) was used.

Next, using a twin-screw extruder (“PCM-30 type” manufactured by Ikegai Co., Ltd.), the mixture was melted and kneaded, so that the melted and kneaded material was obtained. In addition, using a mechanical pulverizer (“Turbo Mill” manufactured by Freund-Turbo Corporation), the melted and kneaded material was pulverized, so that the pulverized material was obtained. Then, using a classifier (“Elbow Jet” manufactured by Nittetsu Mining Co., Ltd.), the pulverized material was classified. In this way, powder-like toner mother particles having a volume median diameter of 6.8 μm were obtained. Note that the volume median diameter (D₅₀) is a median diameter measured using a laser diffraction/scattering type particle size distribution measurement device (“LA-950” manufactured by HORIBA, Ltd.).

### <5-1-3. External Addition to Toner Mother Particles>

Using the FM mixer (“FM-10B” manufactured by Nippon Coke & Engineering Co., Ltd.), 100.0 pts. mass of the toner mother particle described above, 1.0 pts. mass of the silica particles (mean primary particle diameter: 20 nm), and 0.75 pts. mass of aluminum oxide particles (“AEROXIDE (registered trademark) Alu C805” manufactured by Nippon Aerosil Co., Ltd., BET specific surface area: 75 to 105 m²/g) were mixed for 5 minutes under the condition of 4,000 rpm, so that the mixture was obtained. Note that the mean primary particle diameter of the aluminum oxide particles is more than 300 nm. Then, using a sieve of 200 mesh (aperture of 75 μm), the mixture was sieved, and the toner shown in Table 1 was obtained. In the following description, the toner is shown by “T”.

TABLE 1
toner (T)

| volume average | true specific | mother | external additive particle | |
|---|---|---|---|---|
| particle diameter | gravity | particle | alumina particle | silica particle |
| (μm) | (g/cm³) | pts. mass | pts. mass | diameter (nm) |
| 6.7 | 1.2 | 100 | 1 | 20 |

### <5-2. Preparation of Carrier>

The carrier of the developer to be used for the confirmation experiment was prepared by the following method.

### <5-2-1. Preparation of Coating Liquid>

Coat resin solution, at least one of the barium titanate particles and the carbon black particles, and toluene were put into a stainless steel container. Then, using a homogenizer, the contents in the stainless steel container were mixed, so that the coating liquid was obtained. As the barium titanate particles, “BT-01” manufactured by Sakai Chemical Industry Co., Ltd. (mean primary particle diameter: 304 nm) was used. As the carbon black particle, “Ketjenblack (registered trademark) EC300J” manufactured by LION SPECIALTY CHEMICALS CO., Ltd. (mean primary particle diameter: 39.5 nm), which is conductive carbon black, was used.

### <5-2-2. Preparation of Carrier Particles>

Using a fluid bed coating machine (“FD-MP-01 D type” manufactured by Powrex Corporation), 5,000 g of the carrier cores were allowed to flow, while the coating liquid was sprayed to the carrier cores. In this way, the carrier cores coated with the coating liquid were obtained. In this case, as the carrier cores, manganese ferrite cores (manufactured by DOWA IP Creation Co., Ltd.) were used. Next, using an electric furnace, the carrier cores coated with the coating liquid were fired at 200 degrees Celsius for 1 hour, so that the coat layer was formed on the surface of the carrier core. In this way, the carrier particles were obtained.

Here, in the confirmation experiment, carriers C1, C2, and C3, i.e., three types of carriers were used. In other words, three types of developers were used. Characteristics of the carriers C1, C2, and C3 are shown in Table 2. Note that each toner of the developers is the toner T described above. In addition, the toner surface coverage of each developer (i.e., toner concentration) is 20% or more and 45% or less.

Ta [symbol]
carrier

| | | volume average | saturation | | | | |
|---|---|---|---|---|---|---|---|
| | | particle diameter | magnetization | true specific gravity | | | |
| type | coat resin | (μm) | (emu/g) | (g/cm³) | Log₁₀ R | coat resin internal additive | |
| C1 | silicone | 39 | 80 | 4.8 | 10 | CB(4 pts. mass) | BT(10 pts. mass) |
| C2 | silicone | 36 | 70 | 4.8 | 10 | CB(3 pts. mass) | BT(10 pts. mass) |
| C3 | PI + FEP | 35 | 70 | 4.8 | 9 | CB(2 pts. mass) | |

[symbol]

indicates data missing or illegible when filed

As illustrated in Table 2, in the carriers C1 and C2, the coat layer was formed using the coat resin containing silicone resin. In the carriers C1 and C2, as the silicone resin, “KR-255” manufactured by Shin-Etsu Chemical Co., Ltd. (solid content: methylphenyl silicone resin, solid content concentration: 50 mass %) was used. On the other hand, in the carrier C3, the coat layer was formed using the coat resin containing polyimide resin (PI) and fluorocarbon resin (FEP).

A contained amount of the carbon black particles (CB) in the coat layer of the carrier C1 is 4 pts. mass with respect to 100 pts. mass of the coat resin, and a contained amount of the barium titanate particles (BT) in the coat layer of the carrier C1 is 10 pts. mass with respect to 100 pts. mass of the coat resin. A contained amount of the carbon black particles (CB) in the coat layer of the carrier C2 is 3 pts. mass with respect to 100 pts. mass of the coat resin, and a contained amount of the barium titanate particles (BT) in the coat layer of the carrier C2 is 10 pts. mass with respect to 100 pts. mass of the coat resin. A contained amount of the carbon black particles (CB) in the coat layer of the carrier C3 is 2 pts. mass with respect to 100 pts. mass of the coat resin. Note that the coat layer of the carrier C3 does not contain barium titanate particles.

A volume average particle diameter of the carrier core of the carrier C1 is 39 μm, and a saturation magnetization of the carrier core of the carrier C1 is 80 emu/g. A volume average particle diameter of the carrier core of the carrier C2 is 36 μm, and a saturation magnetization of the carrier core of the carrier C2 is 70 emu/g. A volume average particle diameter of the carrier core of the carrier C3 is 35 μm, and a saturation magnetization of the carrier core of the carrier C3 is 70 emu/g.

In addition, when a carrier resistance is R (unit: Q), values of “log₁₀R” of carriers C1 and C2 are approximately 10, and a value of “log₁₀R” of the carrier C3 is approximately 9. Note that the carrier resistance is determined on the basis of a measurement result using a bridge method.

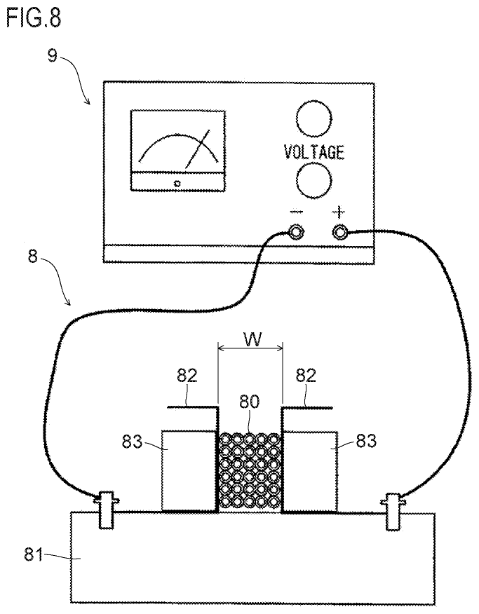

Specifically, in measurement of the carrier resistance, as illustrated in FIG. 8, a bridge type resistance measuring device 8 and a super megohmmeter 9 (“SM-8220” manufactured by HIOKI E.E. Corporation) are used. The bridge type resistance measuring device 8 has a pair of electrode plates 82 fixed on a top surface of a substrate 81 made of acrylic resin. The pair of electrode plates 82 are disposed to face each other with a space W of 1 mm. Surfaces of the pair of electrode plates 82 face each other. A magnet 83 of 1,000 gauss is disposed on each back side of the pair of electrode plates 82. The facing side of each magnet 83 has an area of 3 cm². In this way, a magnetic field is formed between the pair of electrode plates 82.

A carrier sample 80 is set between the pair of electrode plates 82. The amount of the set carrier sample 80 is 0.2 g. The carrier sample 80 is filled between the pair of electrode plates 82, so as to have a chain structure along magnetic field lines. In this state, a DC voltage of 1,000 V (an electric field of 1×10⁶ V/m) is applied between the terminals, and ten seconds later the resistance value is read by the super megohmmeter 9, and the read value (unit: Q) is the carrier resistance (the value of the above “R”).

### <5-3. Evaluation>

In order to check the scatter of the toner from the inside to the outside of the developing device, printing was performed actually. As an evaluation machine, an image forming apparatus (Taskalfa3554ci) manufactured by KYOCERA Document Solutions Inc. was used. The evaluation machine has the same structure as the image forming apparatus PR (the developing device 3 and the replenishment unit 4) illustrated in FIGS. 1 and 2. In addition, as the recording medium, plain A4 paper (“ASKUL Paper” manufactured by ASKUL Corporation) was used.

In Confirmation Experiment 1, the developer containing the toner T and the carrier C1 (hereinafter, may be referred to as a silicone coated developer) was used as the initial developer, and the silicone coated developer containing the toner T and the carrier C1 was used as the replenishment developer. In Confirmation Experiment 1, the coat resin of each carrier C1 of the initial developer and the replenishment developer contains silicone resin.

In Confirmation Experiment 2, the silicone coated developer containing the toner T and the carrier C1 was used as the initial developer, and the developer containing the toner T and the carrier C3 (hereinafter, may be referred to as a fluorine coated developer) was used as the replenishment developer. In Confirmation Experiment 2, the coat resin of the carrier C1 of the initial developer contains silicone resin, the coat resin of the carrier C3 of the replenishment developer contains fluorocarbon resin.

In Confirmation Experiment 3, the silicone coated developer containing the toner T and the carrier C2 was used as the initial developer, and the fluorine coated developer containing the toner T and the carrier C3 was used as the replenishment developer. In Confirmation Experiment 3, the coat resin of the carrier C2 of the initial developer contains silicone resin, and the coat resin of the carrier C3 of the replenishment developer contains fluorocarbon resin.

Printing operations in Confirmation Experiments 1 to 3 were performed simultaneously. Specifically, the developers of the evaluation targets are put into three developing devices of the same evaluation machine, respectively.

In Confirmation Experiment 1, the silicone coated developer (the toner T and the carrier C1) as the initial developer was put into the cyan developing device, and the silicone coated developer (the toner T and the carrier C1) as the replenishment developer was put into the cyan container. As to the replenishment developer in Confirmation Experiment 1, 20 g of the carrier C1 was input with respect to 400 g of the cyan toner, so as to be 5% with respect to a toner mass.

In Confirmation Experiment 2, the silicone coated developer (the toner T and the carrier C1) as the initial developer was put into the magenta developing device, and the fluorine coated developer (the toner T and the carrier C3) as the replenishment developer was put into the magenta container. As to the replenishment developer in Confirmation Experiment 2, 20 g of the carrier C3 was input with respect to 400 g of the magenta toner, so as to be 5% with respect to a toner mass.

In Confirmation Experiment 3, the silicone coated developer (the coat resin of the carrier C2) as the initial developer was put into the black developing device, and the fluorine coated developer (the toner T and the carrier C3) as the replenishment developer was put into the black container. As to the replenishment developer in Confirmation Experiment 3, 20 g of carrier C3 was input with respect to 400 g of the black toner, so as to be 5% with respect to a toner mass.

In each of Confirmation Experiments 1 to 3, printing was performed on 100,000 sheets. Then, scattered toner from the developing device of the evaluation machine was checked every time when printing on 2,500 sheets was completed. In addition, the shear friction coefficient of the developer in the developing device (i.e., the developer currently in use) was checked every time when printing on 2,500 sheets was completed. The results are shown in Tables 3, 4, and 5 as follows. The result of Confirmation Experiment 1 is shown in Table 3, the result of Confirmation Experiment 2 is shown in Table 4, and the result of Confirmation Experiment 3 is shown in Table 5.

TABLE 3
Confirmation Experiment 1

| durability | coverage | | shear friction coefficient | | toner |
|---|---|---|---|---|---|
| condition | rate | printing pattern | carrier | developer | scatter |
| 0K | | | 0.632 | 0.591 | A |
| 25K | 5% | three-sheet intermittent | 0.632 | 0.591 | A |
| 50K | 1% | continuous | 0.632 | 0.591 | B |
| 75K | 5% | three-sheet intermittent | 0.632 | 0.591 | C |
| 100K | 5% | continuous | 0.632 | 0.591 | C |

TABLE 4
Confirmation Experiment 2

| durability | coverage | | shear friction coefficient | | toner |
|---|---|---|---|---|---|
| condition | rate | printing pattern | carrier | developer | scatter |
| 0K | | | 0.632 | 0.591 | A |
| 25K | 5% | three-sheet intermittent | 0.622 | 0.590 | A |
| 50K | 1% | continuous | 0.620 | 0.590 | A |
| 75K | 5% | three-sheet intermittent | 0.611 | 0.589 | A |
| 100K | 5% | continuous | 0.601 | 0.588 | A |

TABLE 5
Confirmation Experiment 3

| durability | coverage | | shear friction coefficient | | toner |
|---|---|---|---|---|---|
| condition | rate | printing pattern | carrier | developer | scatter |
| 0K | | | 0.600 | 0.566 | A |
| 25K | 5% | three-sheet intermittent | 0.593 | 0.567 | A |
| 50K | 1% | continuous | 0.589 | 0.568 | A |
| 75K | 5% | three-sheet intermittent | 0.586 | 0.569 | B |
| 100K | 5% | continuous | 0.579 | 0.571 | B |

Note that, in Confirmation Experiments 1 to 3, printing was performed under the following conditions.

From the first to 25,000th sheets, the coverage rate was set to 5%. In addition, three-sheet intermittent printing was performed, in which a predetermined interval was inserted every three sheets of printing.

From 25,001th to 50,000th sheets, the coverage rate was set to 1%. In addition, continuous printing was performed from 25,001th to 50,000th sheets.

From 50,001th to 75,000th sheets, the coverage rate was set to 5%. In addition, three-sheet intermittent printing was performed, in which a predetermined interval was inserted every three sheets of printing.

From 75,001th to 100,000th sheets, the coverage rate was set to 5%. In addition, continuous printing was performed from 75,001th to 100,000th sheets.

In Confirmation Experiment 1, the initial developer and the replenishment developer are both the silicone coated developer, and each carrier is the carrier C1 using the coat resin containing silicone resin. For this reason, the shear friction coefficient of only the carrier of the developer currently in use (the “shear friction coefficient of carrier” in Table 3) is “0.632”. The shear friction coefficient when the toner surface coverage of the developer currently in use is 34% (i.e., in real use)(the “shear friction coefficient of developer” in Table 3) is “0.591”.

In Confirmation Experiment 2, the initial developer is the silicone coated developer, and is the carrier C1 using the coat resin containing silicone resin. On the other hand, the replenishment developer is the fluorine coated developer, and is the carrier C3 using the coat resin containing fluorocarbon resin.

Here, in Confirmation Experiment 2, along with an increase in the number of printed sheets, the carrier C3 is replenished to the developer currently in use. In other words, the carrier C1 and the carrier C3 are mixed. In this way, the shear friction coefficient of only the carrier of the developer currently in use (the “shear friction coefficient of carrier” in Table 4) approaches from the shear friction coefficient “0.632” of the carrier C1 to the shear friction coefficient “0.529” of the carrier C3.

On the other hand, in Confirmation Experiment 2, the initial developer is the silicone coated developer, while the replenishment developer is the fluorine coated developer, and the shear friction coefficient when the toner surface coverage of the developer currently in use is 34% (the “shear friction coefficient of developer” in Table 4) approaches from “0.591” to “0.582”.

In Confirmation Experiment 3, the initial developer is the silicone coated developer, and is the carrier C2 using the coat resin containing silicone resin. On the other hand, the replenishment developer is the fluorine coated developer, and is the carrier C3 using the coat resin containing fluorocarbon resin.

Here, in Confirmation Experiment 3, along with an increase in the number of printed sheets, the carrier C3 is replenished to the developer currently in use. In other words, the carrier C2 and the carrier C3 are mixed. In this way, the shear friction coefficient of only the carrier of the developer currently in use (the “shear friction coefficient of carrier” in Table 5) approaches from the shear friction coefficient “0.600” of the carrier C2 to the shear friction coefficient “0.529” of the carrier C3.

On the other hand, in Confirmation Experiment 3, the initial developer is the silicone coated developer, and the replenishment developer is the fluorine coated developer. As to the shear friction coefficient when the toner surface coverage 34% (i.e., in real use) (the “shear friction coefficient of developer” in Table 5), the initial developer is “0.566” while the replenishment the shear friction coefficient of the developer is “0.582”, and a difference between them is “0.016”. In addition, the shear friction coefficient of the developer currently in use when the toner surface coverage is 34% approaches to “0.582”.

In Confirmation Experiment 3, there is a difference “0.016” of the shear friction coefficient between the initial developer and the replenishment developer, and hence flowability of the developer changes so that toner scatter due to poor charging of the toner can occur more easily than in Confirmation Experiment 2.

In Confirmation Experiments 1 to 3, the evaluation of toner scatter from the inside to the outside of the developing device was performed by the following criteria. Note that in this evaluation, the toner adhered to a top surface of the developing device was the evaluation target. The top surface of the developing device is denoted by 3T in FIG. 2.
A: There is substantially no toner scatter.
B: There is a little toner scatter (level without no problem).
C: There is much toner scatter (level having a problem).

Before starting printing (durability condition: 0K), in each of Confirmation Experiments 1 to 3, there is substantially no toner scatter, and the evaluation result was “A”.

When printing on 25,000th sheet was completed (durability condition: 25K), in each of Confirmation Experiments 1 to 3, there was substantially no toner scatter, and the evaluation result was “A”.

When printing on 50,000th sheet was completed (durability condition: 50K), in Confirmation Experiment 1, there was a little toner scatter, and the evaluation result was “B”. On the other hand, in each of Confirmation Experiments 2 and 3, there was substantially no toner scatter, and the evaluation result was “A”.

When printing on 75,000th sheet was completed (durability condition: 75K), in Confirmation Experiment 1, there were much toner scatter, and the evaluation result was “C”. On the other hand, in Confirmation Experiment 2, there was substantially no toner scatter, and the evaluation result was “A”, while in Confirmation Experiment 3, the evaluation result was “B”.

When printing on 100,000th sheet was completed (durability condition: 100K), in Confirmation Experiment 1, there were much toner scatter, and the evaluation result was “C”. On the other hand, in Confirmation Experiment 2, there was substantially no toner scatter, and the evaluation result was “A”, while in Confirmation Experiment 3, the evaluation result was “B”.

In Confirmation Experiment 1, it was confirmed that toner particles can easily scatter in durability (printing on 75,000th sheet and after). On the other hand, it was confirmed that in Confirmation Experiments 2 and 3, even in durability (printing on 75,000th sheet and after), scatter of toner particles can be suppressed. The reason is considered because the carrier in the developer currently in use is changed from silicone coated carrier to the fluorine coated carrier. In other words, it is considered because adhesion of the toner to the carrier is stronger in the replenishment developer than in the initial developer.

From these results, it can be said that scatter of toner particles in durability (in long-term use) can be suppressed, by using the silicone coated developer (i.e., the first developer 1) as the initial developer, while using the fluorine coated developer (i.e., the second developer 2) as the replenishment developer.

In addition, although the coating material of the carrier is different between the initial developer and the replenishment developer, because the initial developer is the silicone coated developer while the replenishment developer is the fluorine coated developer, a difference of the shear friction coefficient of the developer in real use (the toner surface coverage is 34%) is small, and hence the flowability of the developer currently in use is stable. In other words, the image density is stable. Because the image density is stable, deterioration in the image quality can be suppressed.

The embodiment disclosed this time is merely an example in every aspect, and should not be considered as a limitation. The scope of the present disclosure is defined not by the above description of the embodiment but by the claims, and it includes all modifications within meaning and scope equivalent to the claims.

What is claimed is:

1. A developer set to be used for development of an electrostatic latent image by a developing device, the developer set comprising:
a first developer stored in the developing device from start of use of the developing device; and
a second developer to be replenished to the developing device after start of use of the developing device, wherein
the first developer includes a first toner containing first toner particles, and a first carrier containing first carrier particles,
the second developer includes a second toner containing second toner particles, and a second carrier containing second carrier particles,
when a shear friction coefficient of the first carrier is A, a shear friction coefficient of the second carrier is B, a shear friction coefficient of the first developer when a surface coverage of the first toner particles with respect to one first carrier particle is 34% is C, and a shear friction coefficient of the second developer when a surface coverage of the second toner particles with respect to one second carrier particle is 34% is D, then A>C and B<D are satisfied, and 0≤|C−D|≤0.016 is satisfied.

2. The developer set according to claim 1, wherein
0≤|C−D|≤0.009 is satisfied.

3. The developer set according to claim 1, wherein
the first carrier particles include a first carrier core coated by a first coat layer,
the second carrier particles include a second carrier core coated by a second coat layer,
the first coat layer contains silicone resin, and
the second coat layer contains fluorocarbon resin.

4. An image forming apparatus comprising:
a developing device configured to develop an electrostatic latent image using the developer set according to claim 1;
a transfer unit configured to transfer the image developed by the developing device onto a sheet; and
a replenishment unit, wherein
the developing device stores the first developer from start of use of the developing device, and
the replenishment unit replenishes the second developer to the developing device after start of use of the developing device.
